(19) United States
(12) Patent Application Publication
(10) Pub. No.: US 2018/0288558 A1
(43) Pub. Date: Oct. 4, 2018

(54) METHODS AND SYSTEMS FOR GENERATING VIEW ADAPTIVE SPATIAL AUDIO

(71) Applicant: OrbViu Inc., San Mateo, CA (US)

(72) Inventors: Frederick William UMMINGER, III, Oakland, CA (US); Brian Michael Christopher WATSON, Groveland, CA (US); Crusoe Xiaodong MAO, Hillsborough, CA (US); Jiandong SHEN, Cupertino, CA (US)

(21) Appl. No.: 15/938,906

(22) Filed: Mar. 28, 2018

Related U.S. Application Data
(60) Provisional application No. 62/479,847, filed on Mar. 31, 2017.

(51) Int. Cl. H04S 7/00; G06F 3/01; G11B 27/038; G06F 3/0481

(52) U.S. Cl. CPC H04S 7/303; G06F 3/04815; G11B 27/038; G06F 3/012

(57) ABSTRACT

A method and system for generating view adaptive spatial audio is disclosed. The method includes facilitating receipt of a spatial audio. The spatial audio comprises a plurality of audio adaptation sets, each audio adaptation set associated with a region among a plurality of regions, each audio adaptation set comprising one or more audio signals encoded at one or more bit rates, each of the one or more audio signals segmented into a plurality of audio segments. The method includes detecting a change in region from a source region to a destination region associated with a change in a head orientation of a user. The source region and the destination region are from among the plurality of regions. Further, the method includes facilitating a playback of the spatial audio by at least in part performing crossfading between at least one audio segment each of the source region and the destination region.

### TECHNICAL FIELD

The present disclosure generally relates to audio and, more particularly to methods and systems for generating view adaptive spatial audio for virtual reality content.

### BACKGROUND

Spatial audio rendered during playback of audio objects is such that a listener perceives a realistic impression of spatial locations of all intended audio sources in the audio object, both in terms of direction and distance. For instance, one example of spatial audio is binaural audio that can be used for providing the spatial audio over headphones. Binaural audio attempts to simulate a binaural recording in which audio objects are encoded using two audio channels (one audio channel each for a left ear canal and a right ear canal). However, since the binaural audio cannot be rotated post-encoding, it poses challenge in virtual reality (VR) applications.

Moreover, spatial audio for VR applications require high bandwidth due to high number of channels required for transmitting the spatial audio. The increase in number of channels requires a high bit rate for transmitting the spatial audio over the channels. A trade off to decrease the bandwidth requirement results in poor quality spatial audio being rendered for VR content. Further, with increase in bit rate of spatial audio, increased CPU usage increases power consumption and poor efficiency. Alternatively, decreasing CPU usage by means of standard processing techniques decreases sound quality of the spatial audio.

In VR applications, rendering audio consistently with changes in the head orientation of the user is vital for the realistic impression to the viewer. The existing techniques provide rendering of spatial audio with the changes in the head orientations (views) of the viewer using multiple tracks of audio and mixing them dynamically based on the current head orientation of the user. However, such techniques require multiple channels for encoding multiple audio objects separately and the encoded multiple audio objects are transmitted via the multiple channels all time, resulting into bandwidth intensive techniques.

In view of the above, there is a need for generation and rendering of novel view adaptive spatial audio that obviates the disadvantages of the existing techniques.

### SUMMARY

Various embodiments of the present disclosure provide methods and systems for generating view adaptive spatial audio.

In one embodiment, a method is disclosed. The method includes facilitating, by a processor, receipt of a spatial audio. The spatial audio comprises a plurality of audio adaptation sets, each audio adaptation set associated with a region among a plurality of regions. Each audio adaptation set comprises one or more audio signals encoded at one or more bit rates. Each of the one or more audio signals is segmented into a plurality of audio segments. The method also includes detecting, by the processor, a change in region from a source region to a destination region associated with a head orientation of a user due to change in the head orientation of the user. The source region and the destination region are from among the plurality of regions. Further, the method includes facilitating, by the processor, a playback of the spatial audio. The playback comprises at least in part to, perform crossfading between at least one audio segment of the plurality of audio segments of each of the source region and the destination region.

In another embodiment, a system is disclosed. The system includes a memory to store instructions and a processor coupled to the memory and configured to execute the stored instructions to cause the system to at least perform a method. The method includes facilitating, by a processor, receipt of a spatial audio. The spatial audio comprises a plurality of audio adaptation sets. Each audio adaptation set associated with a region among a plurality of regions. Each audio adaptation set comprises a plurality of audio signals encoded at a plurality of bit rates. Each audio signal of the plurality of audio signals is segmented into a plurality of audio segments. The method also includes detecting, by the processor, a change in region from a source region to a destination region associated with a head orientation of a user due to change in the head orientation of the user. The source region and the destination region are from among the plurality of regions. Further, the method includes facilitating, by the processor, a playback of the spatial audio. The playback comprises at least in part to, perform crossfading between at least one audio segment of the plurality of audio segments of each of the source region and the destination region.

In yet another embodiment, a VR capable device is disclosed. The VR capable device includes one or more sensors configured to determine head orientation of a user, a memory for storing instructions and a processor coupled to the one or more sensors and configured to execute the stored instructions to cause the VR capable device to at least perform a method. The method includes facilitating, by a processor, receipt of a spatial audio. The spatial audio comprises a plurality of audio adaptation sets. Each audio adaptation set associated with a region among a plurality of regions. Each audio adaptation set comprises a plurality of audio signals encoded at a plurality of bit rates. Each audio signal of the plurality of audio signals segmented into a plurality of audio segments. The method also includes detecting, by the processor, a change in region from a source region to a destination region associated with the head orientation of the user due to change in the head orientation of the user. The source region and the destination region are from among the plurality of regions. Further, the method includes facilitating, by the processor, a playback of the spatial audio. The playback comprises at least in part to, perform crossfading between at least one audio segment of the plurality of audio segments of each of the source region and the destination region.

### BRIEF DESCRIPTION OF THE FIGURES

For a more complete understanding of example embodiments of the present technology, reference is now made to the following descriptions taken in connection with the accompanying drawings in which:

FIG. 1 illustrates an environment, in accordance with an example embodiment of the present disclosure;

FIG. 2 is a flow diagram depicting an example method for generating and playing back view adaptive spatial audio, in accordance with an example embodiment;

FIGS. 3A, 3B, 3C, 3D, 3E. 3F, 3G, 3H, 3I show a simplified representation of different head orientations of a user in an imaginary 3-dimensional sphere surrounding the user's head for generating view adaptive spatial audio, in accordance with an example embodiment;

FIG. 4 is a flow diagram depicting an example method for generating view adaptive spatial audio, in accordance with an example embodiment;

FIG. 5 is a flow diagram depicting an example method for smoothing spatial audio between view transitions of a user during playback, in accordance with an example embodiment;

FIGS. 6A and 6B illustrate schematic representations of change in head orientation of a user within a region, in accordance with an example embodiment;

FIG. 7A is a flow diagram depicting an example method for rotating spatial audio within a region based on change in head orientation of a user during playback, in accordance with an example embodiment;

FIG. 7B is a flow diagram depicting an example method for rotating spatial audio within a region based on change in head orientation of a user during playback, in accordance with another example embodiment;

FIG. 8 illustrates a flow diagram depicting an example method for smoothening and rotating spatial audio when user switches views based on change in head orientation of a user during playback of spatial audio, in accordance with an example embodiment;

FIG. 9 illustrates a schematic representation of spatial audio metadata for audio adaptation sets in spatial audio, in accordance with an example embodiment; and

FIG. 10 is a block diagram of a system configured to generate view adaptive spatial audio, in accordance with an example embodiment.

The drawings referred to in this description are not to be understood as being drawn to scale except if specifically noted, and such drawings are only exemplary in nature.

### DETAILED DESCRIPTION

Various methods and systems for generating view adaptive spatial audio are disclosed.

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various embodiments of the present disclosure provide methods, systems, and computer program products for generating view adaptive spatial audio. It shall be noted that the view adaptive spatial audio is designed for streaming audio over the internet for virtual reality. Moreover, the view adaptive spatial audio is compatible with MPEG-DASH of Http Live Streaming (HLS). Spatial audio changes when the user switches view. The spatial audio is therefore adapted to playback based on head orientation of the user. The region around head of the user is divided into a plurality of regions and at every instant of time, the head orientation of the user is determined in a region of the plurality of regions. The spatial audio is played back to the user based on the region. Spatial audio is therefore generated for each region of the plurality of regions. The spatial audio comprises a plurality of audio adaptation sets such that each audio adaptation set is associated with a region among a plurality of regions. Each audio adaptation set comprises one or more audio signals. Original audio content is encoded at one or more bit rates to generate the one or more audio signals for a region. The one or more audio signals are segmented into a plurality of audio segments on a time scale such as to allow concatenation of audio segments from different audio adaptation sets when the user switches view.

During playback, the head orientation of the user is determined in a region amongst the plurality of regions. The audio adaptation set corresponding to the region is used to render the spatial audio to the user. If the user switches view from a current region to a new region, then an audio segment from the audio adaptation sets corresponding to each of the current region and the new region are fetched and a crossfade function is applied to the audio segment from the current region and the new region such as to smoothen transition of spatial audio due to the view switch of the user. The audio adaptation set of the new region is then used to render spatial audio to the user.

When the head orientation of the user changes within the region but not significantly to move to another region, the spatial audio is rendered by rotating the spatial audio based on change in the head orientation within that region. For instance, when the head orientation of the user changes within the region, such as, rotation of head of the user within a region before a view switch to a new region (the destination region), the spatial audio in the audio adaptation set corresponding to the region is rotated based on change in the head orientation and rendered to the user using spatial interpolation techniques.

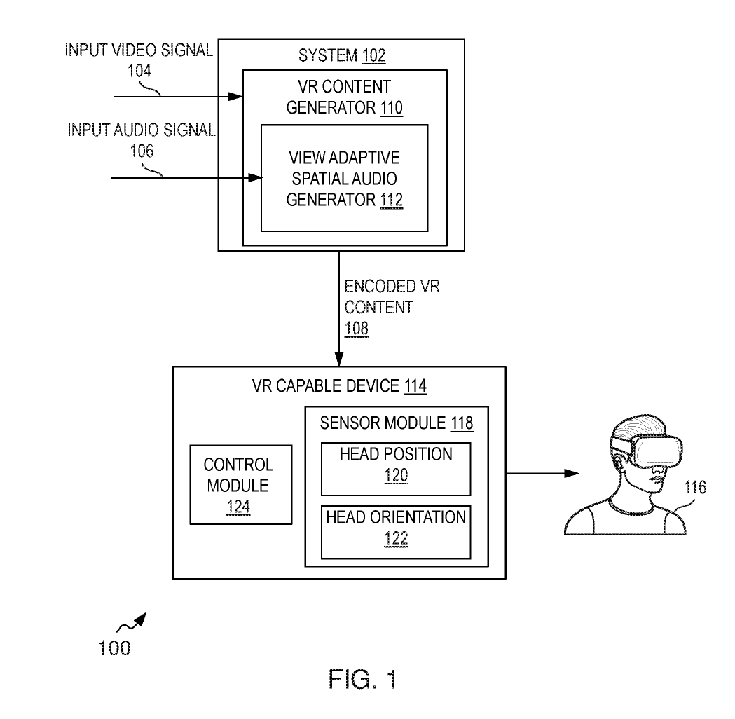

FIG. 1 illustrates an environment 100, in accordance with an example embodiment of the present disclosure. The environment 100 includes a system 102 that receives an input video signal 104 and an input audio signal 106 to generate an encoded VR content 108. The input video signal 104 and the input audio signal 106 are shown as two inputs, however it should be noted that they can be received from a same source such as a VR camera. The system 102 includes a VR content generator 110 that includes audio-video processing components. For instance, the VR content generator 110 includes a view adaptive spatial audio generator 112 and a corresponding video component (not described for the sake of brevity). The input audio signal 106 is processed by the view adaptive spatial audio generator 112 to generate view adaptive spatial audio corresponding to the input video signal 104, such that it can played back at a VR capable device such as a VR capable device 114. In the illustrated example, the view adaptive audio is contained in the encoded VR content 108 that includes the encoded video as well as the view adaptive spatial audio. The VR capable device 114 can be any device that include necessary components (such as one or more processors, head gear, display screen, etc.) or is able to access such components for decoding the encoded VR content 108, and perform a playback of the VR content containing the view adaptive spatial audio.

The encoded VR content 108 including the view adaptive spatial audio is provided to the VR capable device 114 for playback to a user 116 such that during the playback, various disadvantages of conventional systems such as non-smooth audio transition between views (depending upon changes in the head orientation of user during VR playback) and inability to rotate audio in between switching of views, are avoided. In an embodiment, the VR capable device 114 includes a sensor module 118 and a control module 124. The sensor module 118 is configured to track head movements of the user 116 and provide the head orientation information to the VR capable device 114 during playback such that the VR capable device 114 dynamically renders spatial audio based on the head orientation of the user 116. The head orientation information from the sensor module 118 is used by the system 102 to smoothly transition and rotate spatial audio based on head movement of the user 116. For example, the sensor module 118 includes a head position sensor 120 and a head orientation sensor 122 that detect change in the head orientation and determine the position and orientation angle of the head of the user 116. The control module 124 is configured to receive the head movement information from the sensor module 118 and control the operation of the VR capable device 114 for optimally rendering spatial audio to the user 116. For instance, if the sensor module 118 detects a change in the head orientation of the user 116, the control module 124 determines and analyzes the amount of change in the head orientation of the user 116 and directs the VR capable device 114 to either smoothen the spatial audio based on view switch or rotate the spatial audio based on change in the head orientation of the user 116 within a region. It must be noted that the operations of the sensor module 118 and the control module 124 can be embodied in the system 102 or the VR capable device 114 associated with the user 116.

The VR capable device 114 may be locally connected to the system 102 or the encoded VR content 108 can be provided to the VR capable device 114 using a network such as wireless network, local area network, the Internet, a private network, and the like.

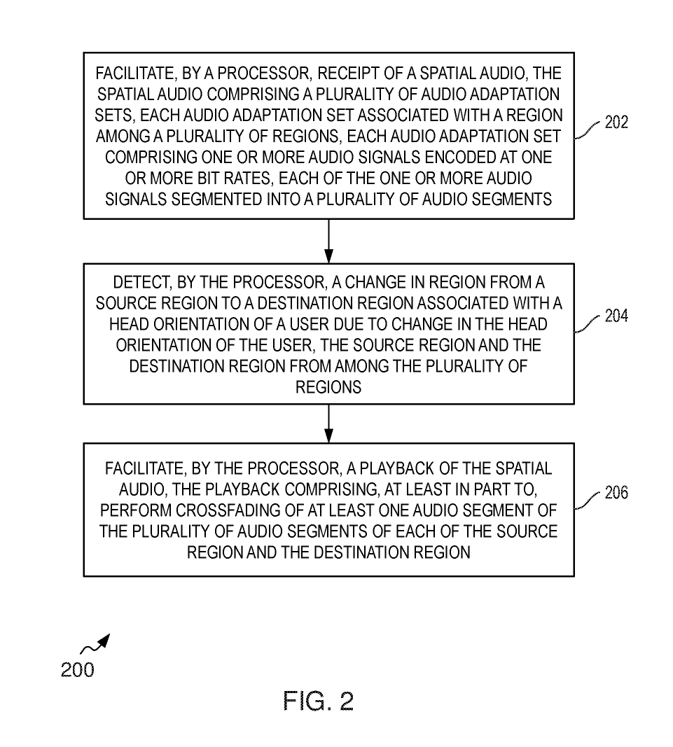

Some example embodiments of generation of the view adaptive spatial audio will be described with reference to FIGS. 2 to 10. It is to be noted that throughout the description, playback of the view adaptive spatial audio at a VR capable device (e.g., the VR capable device 114) is also explained for describing the generation of the view adaptive spatial audio.

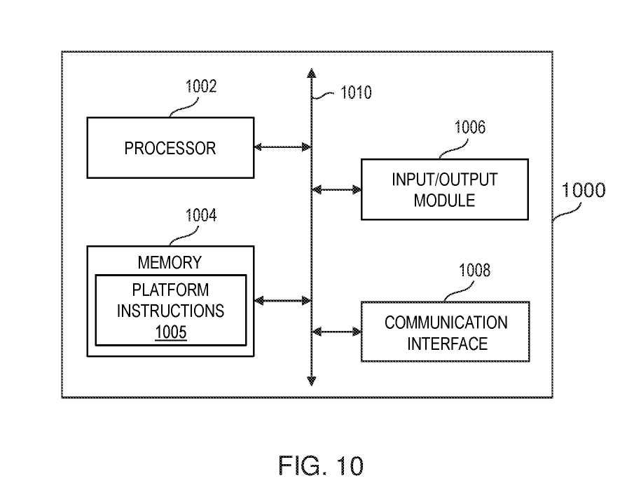

Referring now to FIG. 2, a flow diagram depicting an example method 200 for generating and playing back view adaptive spatial audio is illustrated in accordance with an example embodiment. The operations of the method 200 are performed by the VR capable device 114 and/or a system 1000 (shown and explained with reference to FIG. 10). The sequence of operations of the method 200 need not to be necessarily executed in the same order as they are presented. Further, one or more operations may be grouped together and performed in form of a single step, or one operation may have several sub-steps that may be performed in parallel or in sequential manner.

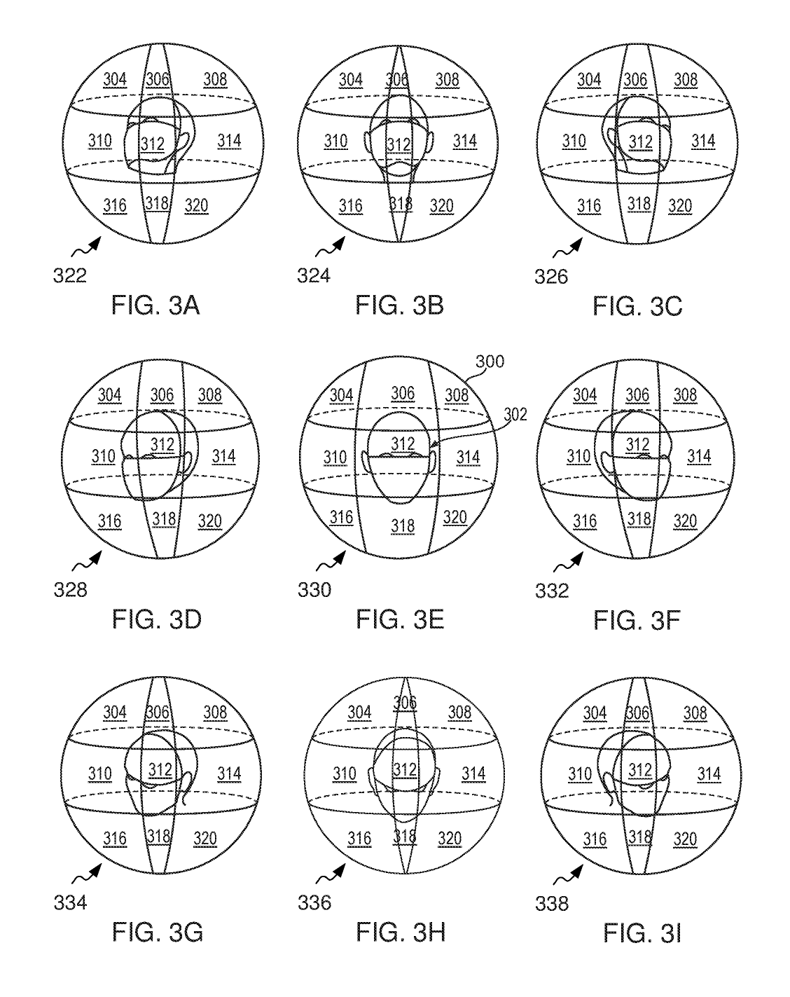

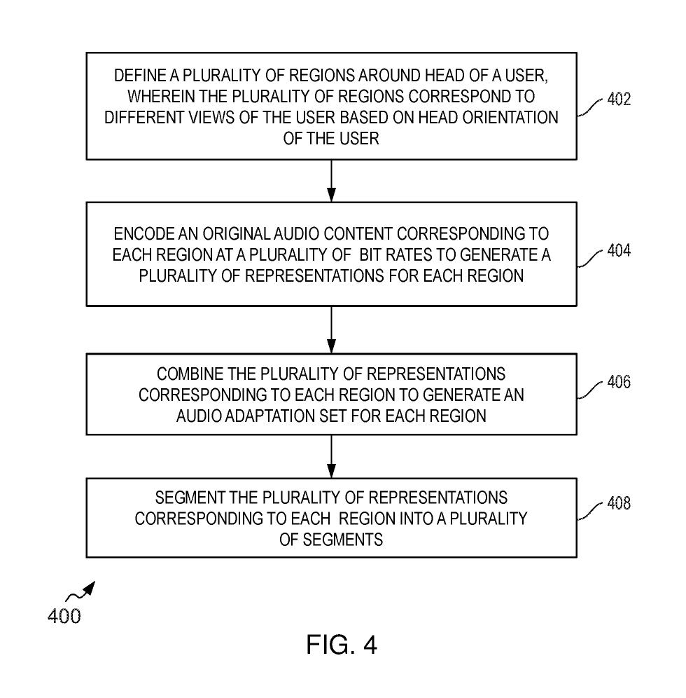

At operation 202, the method 200 includes facilitating, by a processor, receipt of a spatial audio. In an embodiment, the spatial audio comprises a plurality of audio adaptation sets such that each audio adaptation set is associated with a region among a plurality of regions. Each audio adaptation set comprises one or more audio signals encoded at one or more bit rates. The one or more audio signals for a region are generated by encoding original audio content at the one or more bit rates. It shall be noted that the terms ‘audio signal’ and ‘representation’ are used interchangeably throughout the description and refer to original audio content encoded at a bit rate of one or more bit rates. For instance, space around head of user is divided into the plurality of regions and original audio content is encoded at one or more bit rates for each region of the plurality of regions to generate the one or more representations. For example, the original audio content is encoded at bit rates b1, b2, . . . , bn to generate representations P₁₁, P₁₂, . . . , P₁ₙ for region R1. Similarly, the original audio content can be encoded at bit rates b1, b2, . . . , bn to generate plurality of representations P₂₁, P₂₂, . . . , P₂ₙ for region R2. The plurality of representations Pᵤ, P₁₂, . . . , P₁ₙ corresponding to region R1 are combined to generate audio adaptation set A1 for region R1 and plurality of representations P₂₁, P₂₂, . . . , P₂ₙ corresponding to region R2 are combined to generate audio adaptation set A2 for region R2. It shall be noted that the original audio content can be encoded at a single bit rate (e.g., bit rate b1) for the plurality of regions such that each adaptation set comprises a single representation encoded at bit rate b1. In an embodiment, each of the one or more representations is segmented into a plurality of audio segments on a time scale such as to facilitate concatenation of segments from different adaptation sets when the user switches view from one region to another region. The regions are described in detail with reference to FIG. 3A-3I and generation of spatial audio is further explained with reference to FIG. 4.

At operation 204, the method 200 includes detecting, by the processor, a change in region from a source region to a destination region associated with a head orientation of a user due to change in the head orientation of the user. The source region and the destination region are from among the plurality of regions. During playback, the head orientation of the user is continuously determined to playback the spatial audio based on the head orientation. The head orientation of the user is determined in one region from among the plurality of regions by a processor (e.g., the processor 1002 shown in FIG. 10).

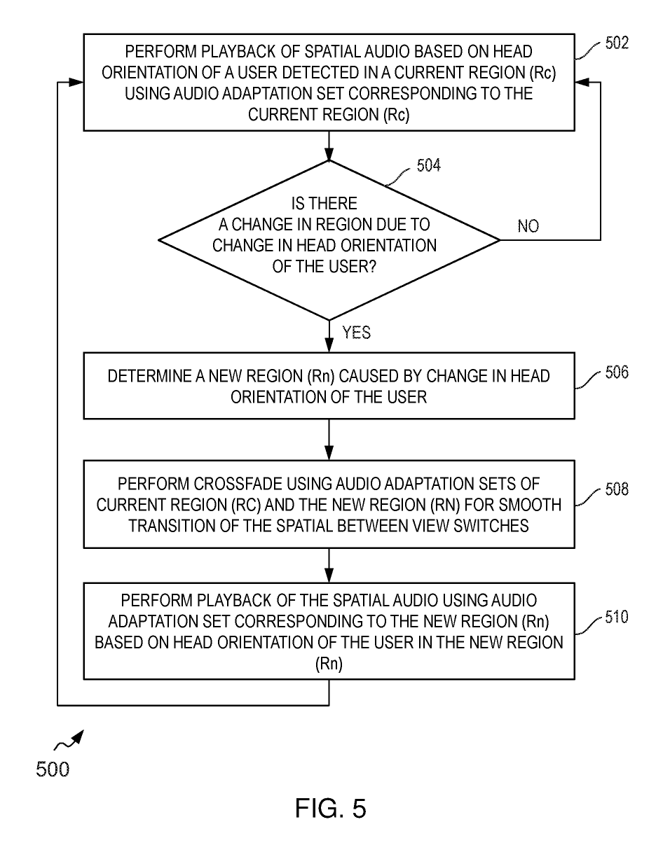

At operation 206, the method 200 includes facilitating, by the processor, a playback of the spatial audio. The playback comprising, at least in part to, performing crossfading between at least one audio segment of the plurality of audio segments of each of the source region and the destination region. For example, if the processor detects the head orientation of the user in the source region R1, the audio adaptation set A1 corresponding to the region R1 is used to playback spatial audio to the user. However, when the head orientation of the user changes from the source region (R1) to the destination region (R2), audio adaptation sets from both regions (the source region R1 and the destination region R2) are temporarily used to render spatial audio to the user, and once crossfading is performed, the audio adaptation set from the region R2 is used to render spatial audio content. In an embodiment, the audio adaptation sets corresponding to both regions are used to perform crossfading such that spatial audio transitions smoothly from an audio adaptation set of the source region (also referred to as ‘current region’) to an audio adaptation set corresponding to the destination region (also referred to as ‘new region’). For example, if the head orientation of the user changes from region R1 to region R2, the audio adaptation sets A1 and A2 are fetched and are used to perform crossfading (during transition time) before rendering spatial audio from the audio adaptation set A2. Smoothening spatial audio when the user switches view is further explained in detail with reference to FIG. 5.

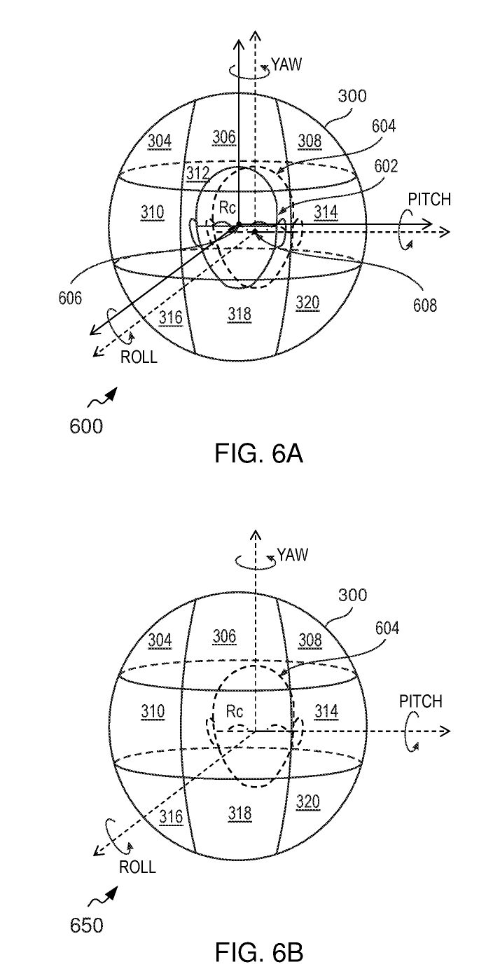

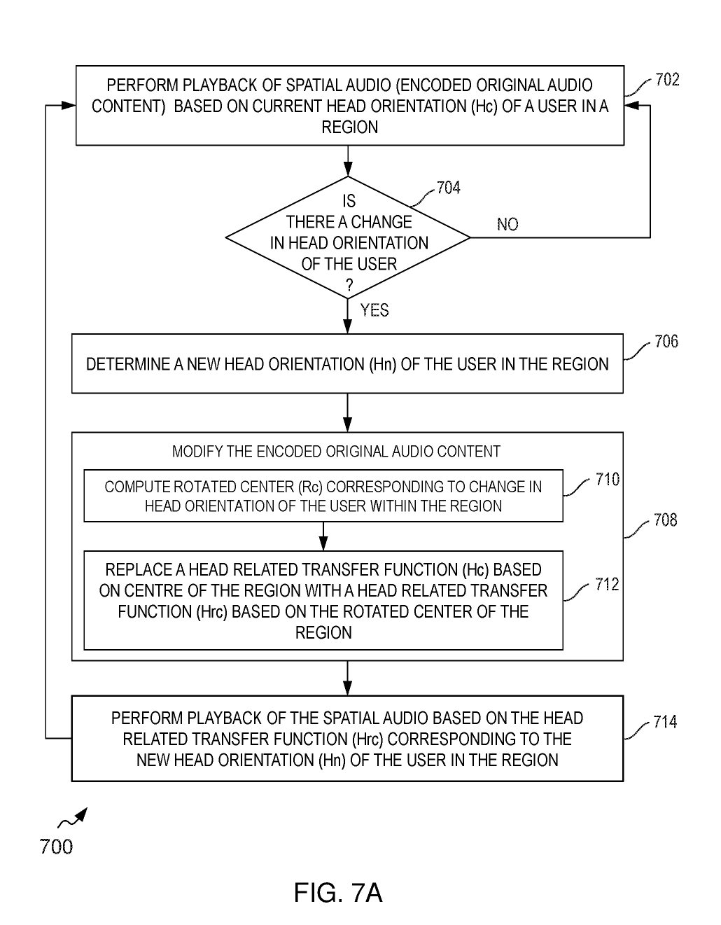

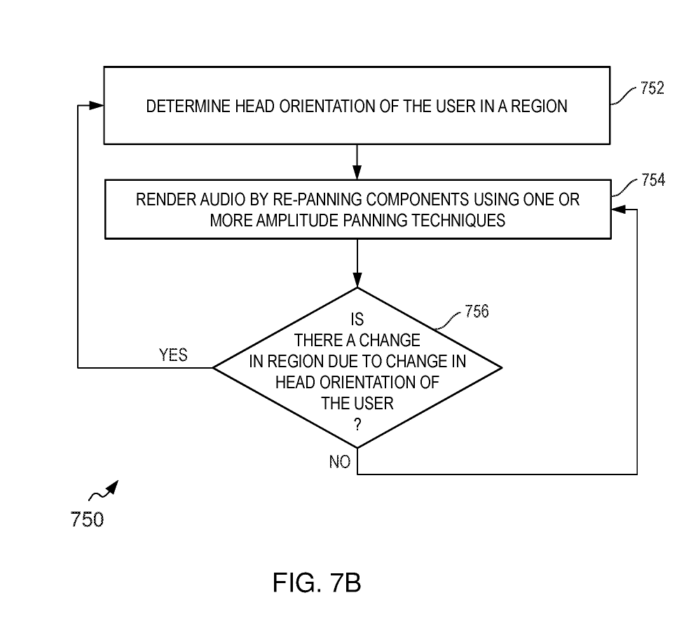

Alternatively, if the head orientation of the user has not changed significantly to move to another region, the spatial audio is rendered by rotating the spatial audio based on change in the head orientation within that region. For instance, when the head orientation of the user changes within the region R1, such as, rotation of head of the user within a region before a view switch to a new region (the destination region), the spatial audio in the audio adaptation set A1 corresponding to region R1 is rotated based on change in the head orientation and rendered to the user using spatial interpolation. In another embodiment, amplitude panning techniques are used to rotate spatial audio when the head orientation of the user changes within the region. Rotating spatial audio based on change in the head orientation of the user within a region is further explained with reference to FIGS. 6A-6B and 7A-7B.

FIGS. 3A to 3I show a simplified representation of different head orientations of a user in an imaginary multi dimensional sphere 300 surrounding a user's head 302 (see, FIG. 3E) for generating spatial audio in accordance with an example embodiment. As described with reference to FIGS. 1 and 2, a view adaptive spatial audio is constituted from adaptation sets in accordance with the different head orientations (corresponding to plurality of regions) of the user while rotating between different views. During playback, the adaptation sets corresponding to the plurality of regions are used to facilitate crossfading and spatial interpolation for different view transitions. In this example representation, space around the head 302 of the user is considered to be the imaginary sphere 300. However, the space around head 302 of the user may be assumed to take any arbitrary shape and can be of any dimension. The sphere 300 is divided into a plurality of spatial regions, say, ‘n’ spatial regions. Each spatial region covers an area in the sphere 300 wherein head movements and head orientations of the user within the sphere 300 are captured and computed to be conformed to at least one spatial region that is closest.

In this example representation, as shown in FIGS. 3A-3I, the imaginary sphere 300 (space around the user's head 302) is divided into 18 spatial regions. In this example representation, the regions 304, 306, 308, 310, 312, 314, 316, 318, 320 are visible and remaining regions are located behind the regions 304, 306, 308, 310, 312, 314, 316, 318, 320 and are not visible. The foregoing description is therefore restricted to the visible regions 304, 306, 308, 310, 312, 314, 316, 318, 320 and the same applies for the regions that are not visible. Each region of the plurality of regions covers a certain degree of the head orientation of the user. For instance, if the imaginary sphere 300 is segmented into 18 regions, each region can cover head orientations upto 60 degrees horizontally and vertically.

It should be noted that the plurality of regions can be segmented into unequal regions and an imaginary surface can assume any arbitrary shape other than the sphere 300. However, it must be noted that the sphere 300 may be divided into any number of spatial regions covering at least a unit space for providing a substantially accurate encoded audio content corresponding to orientation of the head 302 of the user. In an embodiment, the plurality of regions can be segmented into unequal regions and space covered by each region may vary.

FIG. 3A depicts an orientation 322 of the head 302 of the user in the sphere 300. The head orientation 322 corresponds to the head 302 lifted up and inclined towards right side of the user. The head orientation 322 corresponds to the region 304 of the sphere 300. The view of the user corresponds to the head orientation 322 of the user in the sphere 300. Similarly, FIGS. 3B to 3I depict orientations 324, 326, 328, 330, 332, 334, 336, 338, respectively, of the head 302 of the user in the sphere 300. The head orientation 324 corresponds to the head 302 lifted up straight at an angle (looking up) and corresponds to the region 306 of the sphere 300. The head orientation 326 corresponds to the head 302 lifted up and inclined towards left side of the user. The head orientation 326 corresponds to the region 308 of the sphere 300.

The head orientation 328 corresponds to the head 302 slightly inclined towards right in a horizontal direction of the user. The head orientation 328 corresponds to the region 310 of the sphere 300. The head orientation 330 corresponds to the head 302 looking straight front. The head orientation 330 corresponds to the region 312 of the sphere 300. The head orientation 332 corresponds to the head 302 slightly inclined towards left side of the user. The head orientation 332 corresponds to the region 314 of the sphere 300. Similarly, head orientations 334, 336, 338 corresponds to the head 302 looking down at an angle and inclined towards right side of the user, looking down and looking down at an angle and inclined towards left side of the user, respectively. The head orientations 334, 336, 338 correspond to the region 316, 318 and 320, respectively, of the sphere 300.

FIG. 4 is a flow diagram of an example method 400 for generating spatial audio for VR applications, in accordance with an example embodiment. In this embodiment, the method 400 depicts generation of spatial audio for virtual reality content. The operations of the method 400 are performed in the view adaptive spatial audio generator 112 and/or the VR capable device 114 containing such view adaptive spatial audio generator 112. The sequence of operations of the method 400 need not to be necessarily executed in the same order as they are presented. Further, one or more operations may be grouped together and performed in form of a single step, or one operation may have several sub-steps that may be performed in parallel or in sequential manner.

It must be noted that in VR applications, a head orientation of the user may correspond to a view of the user, and change in the head orientation from one region to another region constitute switching views of the user from one region to another region. Accordingly, the terms ‘head orientation’, ‘view of the user’ have been used interchangeably throughout the description. Similarly, terms such as, ‘change in the head orientation’ and ‘switching views’ have also been interchangeably used in the present description. Further, the terms ‘spatial audio’, ‘spatial audio signal’, as used throughout the description refer to encoded audio content for each region such that a listener (also the user) perceives a realistic impression of spatial locations of intended audio sources from the encoded audio content, both in terms of direction and distance. Examples of the spatial audio include, but are not limited to, binaural audio, M-S (mid-side), 5.1 surround sound, 7.1 surround sound, higher channel formats (22.2, Auro-3D), ambisonics, and object based formats such as Dolby Atmos®, DTS-X, MPEG-H 3D. Moreover, terms such as ‘binaural audio’ and ‘binaural signal’ have been used interchangeably throughout the description and refer to audio that is from, or attempts to simulate, a binaural recording. Binaural recording is performed by inserting a microphone in each ear to emulate a sensation of being present in an environment of sound source (e.g., performers, instruments). At many places throughout the present description, spatial audio has been described by way of example of binaural audio, and it should not be considered to as limiting to the scope of present invention. It should be understood that such description may equally be applicable for other types of spatial audio as described above.

At 402, the method 400 includes defining, by the processor, a plurality of regions around head of a user. The regions around the head of the user can assume any arbitrary shape in an imaginary space. A user's head orientation can be described based on roll, pitch and yaw. For instance, if pitch and yaw are used to describe direction of view of the user (i.e. direction towards which face of the user is pointing), the imaginary space around the head of the user is a two-dimensional space (e.g., surface of the sphere) covering all directions from a point in a three dimensional space. In another example, if roll, pitch and yaw are used to describe direction of view of the user, the direction of the user's view and an angle corresponding to rotation around an axis based on direction of the user's view is provided. In such cases, the imaginary space around head of the user is a three dimensional (3-D) space, such as, special orthogonal group of a 3-D space (SO(3)), that consists of all rotations of the 3-D space. Herein, a surrounding imaginary sphere (a 3-D shape) is considered for the purpose of explanation of the present description and it must not be considered as limiting the scope of the invention.

In one non-limiting example, an imaginary sphere may be assumed around head of the user, and the imaginary sphere may be divided into the plurality of regions. The plurality of regions corresponds to different views of the user based on the head orientation of the user. Each region of the plurality of regions corresponds to a head orientation of the user. For example, a thirty degree head movement in a horizontal/vertical direction falls within range of first region of the sphere and another thirty degree head movement horizontally/vertically from edge of the first region falls within a second region. If the view of the user (the head orientation) is inclined at twenty degrees, then head position is classified as belonging to the first region. Classification of the head orientation to respective region of the plurality of regions is further explained with reference to FIGS. 3A-3I.

At 404, the method 400 includes encoding an original audio content corresponding to each region at a plurality of bit rates to generate a plurality of representations for each region. For instance, considering example of ‘spatial audio’ being the ‘binaural audio’, the plurality of representations for a region is generated by performing binaural encoding (at the plurality of bit rates) of the original audio content corresponding to the region. The original audio content corresponding to a left auditory canal and a right auditory canal are encoded at different bit rates to generate the plurality of representations for that region. For example, binaural encoding of original audio content corresponding to left auditory canal for a region R1 is performed at bit rates b1, b2, . . . , bn to generate representations LP₁, LP₂, . . . , LPₙ for the left auditory canal and binaural encoding of original audio content corresponding to right auditory canal for a region R1 is performed at bit rates b1, b2, . . . , bn to generate representations RP₁, RP₂, . . . RPₙ for the right auditory canal in the region RE It shall be noted that the original audio content corresponding to the left auditory canal is encoded at bit rates identical to the right auditory canal such as to generate representations for each region (e.g., the region R1). In an embodiment, the original audio content can be generated from multiple audio files corresponding to many audio sources placed at different positions. It is to be noted that operation of step 404 is performed to generate the plurality of representations corresponding to each of the plurality of regions.

As shown by block 406, the plurality of representations corresponding to each region is combined to generate an audio adaptation set for each region. For instance, binaural encoding of the original audio content for the region R1 generates left audio files comprising representations LP₁, LP₂, . . . , LPₙ and right audio files comprising representations RP₁, RP₂, . . . RPₙ that are to be rendered for a specific head orientation of the user in the region. The left audio files and the right audio files are combined together to generate the audio adaptation set A1 for the region RE The left audio files are encoded at different bit rates (b1, b2, . . . , bn) identical to the right audio file for the region R1 to generate the plurality of representations (e.g., operation of the block 404) for the region R1.

At 408, the method 400 includes segmenting the plurality of representations corresponding to a region into a plurality of segments. The plurality of representations of an adaptation set corresponding to a region are segmented on a time scale in a consistent way for each representation in the adaptation set and between all adaptation sets that correspond to views of the same content. For instance, the plurality of representations LP₁, LP₂, . . . , LPₙ and RP₁, RP₂, . . . RPₙ (encoded left audio files and right audio files) are broken down into smaller audio segments in time such as to facilitate concatenation of segments from different adaptation sets when the user switches view from one region to another region. For example, during playback when the head orientation of the user changes from one region (current region) to another region (e.g., new region), a processor switches from playing back spatial audio from an audio adaptation set corresponding to the current region to an audio adaptation set corresponding to the new region. More specifically, the processor switches from playing back a segment of the audio adaptation set corresponding to the current region to another segment of the audio adaptation set corresponding to the new region for optimal rendering of spatial audio format for each view (corresponding to the head orientation) of the user. Such process is explained later in the present description with reference to FIG. 5.

In an embodiment, during playback the processor in the VR capable device 114 utilizes the audio adaptation sets corresponding to view switches (regions corresponding to change in the head orientation) of the user to smoothly transition (crossfade) between rendering of spatial audio for different regions. For instance, in an embodiment, the processor ensures smooth crossfading by first fetching audio adaptation sets corresponding to encoded audio content from both regions (e.g., current region and new region, before and after change in the head orientation, respectively) during a transition and then performing crossfading. In another embodiment, the processor is configured to fetch an audio segment from an audio adaptation set of a current region and an audio segment staggered in time from a special audio adaptation set corresponding to the new region and perform crossfading between the audio adaptation set of the current region and the special audio adaptation set of the new region. In yet another embodiment, audio adaptation sets can be used for crossfading between multiple audio streams based on geometric position, for example, barycentric coordinates used as mixing weights to combine the audio streams. A method for smoothing (crossfading) spatial audio when the head orientation of a user changes from one region to another region is explained with reference to FIG. 5.

FIG. 5 is a flow diagram depicting an example method 500 for smoothing spatial audio between view transitions of a user during playback, in accordance with an example embodiment. The method 500 can be performed by a processor present in the VR capable device 114. The sequence of operations of the method 500 need not to be necessarily executed in the same order as they are presented. Further, one or more operations may be grouped together and performed in form of a single step, or one operation may have several sub-steps that may be performed in parallel or in sequential manner.

The method starts at operation 502. At 502, perform playback of spatial audio based on the head orientation of a user detected in a current region (Rc). In an embodiment, an audio adaptation set corresponding to the current region (Rc) is used to perform playback of the spatial audio to the user. The spatial audio is optimally rendered to a user based on the audio adaptation set corresponding to the region (Rc) in which the head orientation of the user is determined. In an embodiment, the spatial audio switches between audio segments of plurality of representations within the adaptation set of the current region based on bandwidth requirements while playback.

At 504, the method 500 includes checking if there is a change in region due to change in the head orientation of the user. For instance, when the user moves his head to a different view, the head orientation of the user changes to a new region. If there is no change in region corresponding to the head orientation of the user, operation at 502 is repeated else operation at 506 is performed.

At 506, the method 500 includes determining a new region (Rn) corresponding to the head orientation of the user. Determining and classifying the region corresponding to the head orientation of the user has been explained with reference to FIGS. 3A-3I.

At 508, the method 500 includes performing crossfading using the audio adaptation sets corresponding to regions (Rc and Rn) based on change in the head orientation of the user for smooth transition of the spatial audio between view switches. For instance, when the user switches views from a source region (e.g., region 304 in FIG. 3A) to a destination region (e.g., region 306 in FIG. 3B) during playback, the processor is configured to perform crossfading using suitable crossfading algorithms based on an audio adaptation set corresponding to the region 304 and an audio adaptation set corresponding to the region 306. More specifically, during crossfading, the processor causes a switch from an audio segment (non-overlapping audio segment and/or overlapping audio segment) of the audio adaptation set corresponding to the region 304 to an audio segment (non-overlapping audio segment and/or overlapping audio segment on time scale) of the audio adaptation set corresponding to the region 306 in one or more ways. In an embodiment, during playback, pops and clicks while switching between audio segments can be mitigated by overlapping the audio segments of the two different regions when the user switches views (change in region based on the head orientation).

Crossfading can be performed using one or more suitable techniques, and it is not limited to only one specific technique. In an embodiment, the audio segments can be overlapped by performing crossfading using the audio adaptation sets corresponding to the two different regions (source region Rc and destination region Rn). For instance, audio segments from audio adaptation sets corresponding to both regions (regions corresponding to before and after change in the head orientation of the user) are fetched to perform crossfading during a transition between the regions (from region Rc to region Rn). For example, when the user switches view from a source region R1 to a destination region R2, the processor accesses source audio segment a₁₁ from audio adaptation set A1 corresponding to the region R1 (view 1 of the user) and destination audio segment a₂₂ (view 2 of the user) from audio adaptation set A2 corresponding to the region R2. Assuming, an interval time (I) between start of two adjacent audio segments in a representation of the audio adaptation set, then duration of an audio segment (D) is such that interval time(I)=duration of an audio segment (D). When the view switch of the user occurs from region R1 to R2, audio segments a₁₁ and a₂₂ are fetched from adaptation sets A1, A2, respectively for transition time T and a basic crossfade is performed during the transition time (T) by the processor. The crossfading is performed to facilitate concatenation of audio segments from audio adaptation sets corresponding to the source region and the destination region. It must be noted that such basic crossfading always starts at the end of an audio segment or, equivalently, start of a subsequent audio segment.

Alternatively, the VR capable device uses special audio adaptation sets, or additional information assigned to the audio adaptation sets for performing seamless crossfading when switching views between regions. In an embodiment, special audio adaptation sets comprise audio segments in which adjacent audio segments (or subsequent audio segments) overlap. These overlapping audio segments are used to perform crossfading between audio segments of different regions when the user switches view. Specifically, the special audio adaptation sets comprise audio segments whose segment durations are D=I+T, where I is the interval of time between adjacent audio segments and ‘T’ is the transition time. This indicates that the adjacent audio segments in the special audio adaptation set overlap by the transition time ‘T’ seconds. When a view switch occurs from region R1 (source region) to region R2 (destination region), a VR capable device (e.g., the VR capable device 114 shown in FIG. 1) is configured to access a source audio segment (e.g., audio segment sa₁₃) from a special audio adaptation set SA1 corresponding to the source region (region R1) and a destination audio segment (e.g., audio segment sa₂₄) from a special audio adaptation set SA2 corresponding to the destination region (region R2). The audio segments sa₁₃ and sa₂₄ fetched from audio adaptation sets SA1 and SA2 overlap for a transition time T during which the spatial audio generator performs a basic crossfade using a crossfade function.

When there are no view switches by the user, while playing back audio segments from special audio adaptation sets (e.g., SA1 comprising overlapping audio segments sa₁₁, sa₁₂, . . . , sa₁ₙ), the VR capable device is configured to play the subsequent audio segment (sa₁₂) in the audio adaptation set SA1 only after a delay from start time of the subsequent audio segment, for example, T seconds into the subsequent audio segment (sa₁₂). Such playback ensures that the subsequent audio segment (sa₁₂) when played back does not overlap with previously played audio segment (sa₁₁). Alternatively, while playing back subsequent audio segments in the special audio adaptation sets, the VR capable device can perform basic crossfading between adjacent audio segments. For example, if the spatial audio is played back from the special audio adaptation set SA1, the VR capable device performs a crossfade between audio segment sa₁₁ and sa₁₂ for the duration in which the adjacent segments overlap for the transition time ‘T’. Although crossfading between audio segments in a special audio adaptation set is less efficient, this technique employs simpler logic and consistent processor usage. Such technique of crossfading using the special audio adaptation sets requires storing same number of audio segments such as ordinary DASH or HLS, but each audio segment contains (I+T)/I times as much audio.

In another embodiment, the special audio adaptation sets comprise audio segments that are staggered in time. For instance, for every audio segment in an audio adaptation set there exists a corresponding audio segment staggered in time in the special audio adaptation set. During a view switch from the source region R1 to the destination region R2, a source audio segment from the source region R1 and destination audio segment staggered in time from the special audio adaptation set corresponding to the destination region R2 are fetched for facilitating crossfading between the source audio segment and the destination audio segment staggered in time using a crossfade function. For instance, for every audio segment in an audio adaptation set, there is a staggered audio segment in a special audio adaptation set whose start time is exactly 1/N of the audio segment duration (D) later than the start time of the audio segment in the audio adaptation set. During playback, non-overlapping audio segments (on time scale) from the audio adaptation sets are played back until a view switch occurs. When the view switch occurs from region R1 to R2, the VR capable device fetches an audio segment (a₁₂) from the audio adaptation set (A1) and a staggered audio segment (sa₂₂) from the special audio adaptation set SA2 corresponding to region R2. The audio segment (a₁₂) and the staggered audio segment (sa₂₂) will overlap for a transition time T=D/N during which the VR capable device performs a basic crossfade using the crossfade function.

It must be noted that crossfading always starts T seconds before the end of an audio segment or, equivalently, D−T seconds after the start of the audio segment when using the special audio adaptation sets that overlap. In a non-limiting example, assuming interval of time between adjacent audio segments (I)=1 second, transition time (T)=0.02 seconds, source audio segment sa₁₁ from the special audio adaptation set SA1 (of source region R1) starts at time 0.990 seconds and ends at time 2.010 seconds (duration of audio segment sa₁₁ is D=1.01 seconds) whereas destination audio segment sa₂₂ from the special audio adaptation set SA2 (of destination region R2) starts at time 1.990 seconds and ends at time 3.010 seconds (duration of audio segment sa₂₂ is D=1.01 seconds). The audio segments sa₁₁ and sa₂₂ overlap from time 1.990 seconds to time 2.010 seconds indicating T=0.02 seconds. When the user switches view from region R1 to R2, the crossfading between the audio adaptation sets sa₁₁ and sa₂₂ starts at time 1.990 seconds, which is 0.020 seconds before the end of the audio segment sa₁₁ (which is at time 2.010 seconds) and D−T=1 s after the start of the audio segment sa₁₁ at 0.990 s. In order to switch views between audio segments sa₁₁ and sa₂₂, change in region of the head orientation of the user must occur before time 1.990 second when the crossfading begins (D−T=1 second after the start of the audio segment sa₁₁ at time 0.990 seconds). If a user switches views later than D−T seconds after the start of the audio segment then no crossfading happens until D−T seconds after the start of the subsequent audio segment. For example, if head movement of the user is not detected before D−T seconds (1 second), then the next option to begin a crossfade is at time 2.990 seconds (1 second after the start of segment sa₂₂).

In an alternate embodiment, crossfading between multiple audio streams can be performed based on geometric position, for example using barycentric coordinates as mixing weights to combine the multiple audio streams. For instance, regions that correspond to views are modelled as triangles or modified to appear as triangles. If each region corresponds to a triangle, original audio content can be encoded to generate spatial audio format for each vertex of the triangle. For any head orientation of the user, the head orientation is described by a vector pointing in a direction the user is viewing a region. The vector (view vector) pointing in the direction of view of the user when extended intersects with a triangular region. The intersection of the view vector with the triangular region at a vertex can be described using barycentric coordinates. During playback, spatial audio is played back to the user as constructed from audio streams corresponding to each of the three vertices of the triangular region (the audio adaptation sets corresponding to the vertices). For example, the processor accesses at least one audio stream corresponding to each vertex of a plurality of vertices associated with the head orientation of the user in at least one region of the plurality of regions. The spatial audio is rendered to the user based on the head orientation of the user in the at least one region by applying the mixing weight to the at least one audio stream from each vertex based at least on barycentric coordinates. For instance, during playback, spatial audio is played back to the user as constructed from audio streams corresponding to each of the three vertices of the triangular region (the audio adaptation sets corresponding to the vertices). The spatial audio is constructed by mixing audio streams from the three vertices where the mixing coefficient (also referred to as ‘mixing weight’) for the spatial audio is a function of the barycentric coordinate corresponding to that vertex. The mixing coefficient may either be the barycentric coordinate of the vertex or square of the barycentric coordinate. This method eliminates need for crossfade between the audio adaptation sets of regions when user switches views. Such techniques, using barycentric coordinates are easier to integrate into existing adaptive streaming solutions. Additionally, this method easily pans the spatial audio when the user remains in a region. However, using barycentric coordinates for crossfading between multiple audio streams requires 3 audio signals; one for each vertex of the triangular region that has to be sent at all times and thereby, negates some of the bandwidth benefits of view adaptive spatial audio.

At operation 510, the method 500 includes performing playback of the spatial audio using the audio adaptation set corresponding to the new region (Rn) based on the head orientation of the user in the new region (Rn). The method 500 continues to playback spatial audio to the user based on the region corresponding to the head orientation of the user after crossfading until a change in the head orientation of the user is detected.

In an example, user switches view from a region (e.g., region 304 shown in FIG. 3A) at time t1 to a region (e.g., region 306 shown in FIG. 3B) at time t2. The processor (e.g., the control module 124 in the VR capable device 114) plays back audio segments from the audio adaptation set corresponding to the region 304 at time 0-t1. In this example, at time t1, when the processor detects a change in region corresponding to the head orientation (view switch) of the user, the processor adapts and begins a transition to playback audio segments from an audio adaptation set corresponding to the region 306. At time t1<t<t2, audio segments from the audio adaptation sets corresponding to the region 304 and the region 306 are played back simultaneously by the processor so as to perform crossfading while transitioning from the region 304 to the region 306. For instance, at time t1<t<t2, audio segment of the audio adaptation set corresponding to the region 304 fades out whereas audio segment of the audio adaptation set corresponding to the region 306 becomes prominent. Specifically, at time t1, audio segment of the audio adaptation set corresponding to the region 304 is played back at full volume while audio segment of the audio adaptation set corresponding to the region 306 is muted. At time t2, audio segment of the audio adaptation set corresponding to the region 304 is muted and audio segment of the audio adaptation set corresponding to the region 306 is played at full volume. At time t1<t<t2, volumes of audio segments corresponding to the two regions (region 304 and region 306) transition smoothly (e.g., a linear change) between these values. Finally, after time t2, audio segment of the audio adaptation set corresponding to region 306 is played back to the user. For example, let ‘ƒ’ denote a crossfade curve function defined for numbers x, where 0<x<1. The crossfade curve function ƒ(x) can be defined to be a monotonically increasing function, such as

$$f ( x ) = x , f ( x ) = sin ( \frac{x}{π / 2} )$$

and/or monotonically decreasing function, such as, ƒ(x)=1−x², ƒ(x)=3x²−2x³. With reference to the above example, at time t1<t<t2, the VR capable device applies a monotonically decreasing function (e.g., ƒ(x)=1−x²) to the audio segment from region 304 and a monotonically increasing function (e.g., ƒ(x)=x) to the audio segment corresponding to region 306 so as to perform crossfading between the audio segments of regions 304, 306 when the user switches view from the region 304 to the region 306.

Referring now to FIGS. 6A and 6B, schematic representations of change in the head orientation of a user within a region 312 is illustrated in accordance with an example embodiment. The imaginary sphere 300 (shown and explained with reference to FIGS. 3A-3I) comprising regions 304 to 320 has been considered for explaining the change in the head orientation of the user within the region 312. In a non-limiting example, the head orientation of the user may slightly change within a region while viewing virtual reality content. In an embodiment, the change in the head orientation within the region has to be tracked in order to rotate spatial audio rendered to the user based on the head orientation of the user. For instance, the head orientation of the user may change from position 602 to position 604 in the region 312. The positions 602 and 604 lie within the same region 312. Although the change in the head orientation of the user does not result in change in region corresponding to the head orientation, the spatial audio has to be rotated based on change in the head orientation within the region. FIG. 6A depicts centre 606 (Rc) of the spatial region 312 with reference to the head orientation of the user at the position 602. The head orientation of the user is defined in terms of yaw, pitch and roll with reference to the centre Rc of the spatial region 312. The spatial audio is rendered to the user within the region based on the head orientation at the position 602. When the head orientation of the user change from position 602 to position 604, the centre 606 (Rc) of the spatial region 312 changes to centre 608 (Rrc) (hereinafter referred to as ‘rotated centre 608’). The rotated centre 608 (Rrc) acts as reference for defining a new head orientation (Hn) of the user in the region 312 in terms of yaw, pitch and roll. The spatial audio has to be rendered to the user based on the new head orientation (Hn) of the user based on rotated centre 608 (Rrc). Change in the head orientation of the user to position 604 depicting rotated centre 608 (Rrc) is shown in FIG. 6B. Rotating spatial audio based on change in the head orientation of the user is shown and explained with reference to FIGS. 7A-7B.

Referring now to FIG. 7A, a flow diagram depicting an example method 700 for rotating spatial audio within a region based on change in the head orientation of a user during playback is illustrated in accordance with an example embodiment. The method 700 can be performed by the system 1000 (described with reference to FIG. 10) and has been explained with reference to binaural audio. However, it must be noted that the system 1000 can be applied to any of the spatial audio formats. The sequence of operations of the method 700 need not to be necessarily executed in the same order as they are presented. Further, one or more operations may be grouped together and performed in form of a single step, or one operation may have several sub-steps that may be performed in parallel or in sequential manner.

At operation 702, the method 700 includes performing playback of spatial audio based on the current head orientation (Hc) of a user in a region. Referring back to FIG. 4, the original audio content maybe encoded by applying an HRTF that corresponds to position of each of the audio sources. The term ‘original audio content’ refer to audio objects from mono audio sources, each originating from a defined position. The encoded original audio content generates a left ear audio signal and a right ear audio signal for each audio source. All the left ear signals are combined to generate a final left ear signal and all the right ear signals are combined to generate a final right ear signals. The final left ear signals and final right ear signals are further encoded using any ordinary audio codec such as mp3, mp4 or Advanced Audio Coding (AAC) to generate encoded audio object that is encoded at different bit rates to generate an audio adaptation set for a region (Ri) that comprises a plurality of representations (based on different bit rates used for encoding process). The plurality of representations in the audio adaptation set are segmented consistently into segments, so as to enable the system 1000 to switch between the segments of the plurality of representations during playback of spatial audio based on the head orientation of the user within the region (Ri). During playback, the processor 1002 is also configured to switch between segments of different audio adaptation sets corresponding to various regions (Ri, where i=1, 2 . . . n) based on user switching views (change in the head orientation of the user).

As described with reference to FIG. 4, the spatial audio is played back based on the current head orientation (Hc) of the user in a region. For instance, if the current head orientation (Hc) of the user is determined in region R2, centre (C₂₁) of the spatial region R2 is determined based on the current head orientation (Hc) of the user. The centre (C₂₁) of the spatial region is used in the HRTF to encode the original audio content. The HRTF can be modified using a variety of interpolation algorithms. The encoded audio object based on centre (C₂₁) of the head orientation is played back to the user to provide a realistic perception of audio sources.

At operation 704, the method 700 includes checking if there is a change in the head orientation of the user. For instance, when the user moves his head slightly, the head orientation of the user may change within the region. The change in the head orientation within the region changes centre of spatial area corresponding to the region in which the head orientation of the user is detected. It must be noted that operation at 704 determines only if there is change in the head orientation within a region and does not apply to determining if there is a change in region due to change in the head orientation of the user. If there is no change in the head orientation of the user, operation at 702 is repeated else operation at 706 is performed.

At operation 706, the method 700 includes determining a new head orientation (Hn) of the user in the region caused by change in the head orientation of the user. The head orientation of the user may change when the user switches views while viewing virtual reality content, and accordingly, the head orientation of the user may change within the region. The detection of the head orientation of the user in a region of the plurality of regions is explained with reference to FIGS. 3A-3I.

At operation 708, the method 700 includes modifying the encoded audio object. The operation 708 can be performed by operations 710, 712 in parallel or sequential manner.

At operation 710, the method 700 includes computing rotated center (Rc) corresponding to new head orientation (Rn) of the user within the region. For instance, if three degrees of freedom, such as, yaw, pitch and roll are allowed for rotation of the spatial audio, the head orientation of the user is determined in terms of yaw, pitch and roll with reference to centre of spatial area (based on the current head orientation Hc). When the head orientation of the user changes within the region, the centre of the spatial region moves to a different location (rotated centre Rc) in the region based on the head orientation of the user. The rotated centre Rc is used to determine the new head orientation (Rn) of the user in the region.

At operation 712, the method 700 includes replacing a head related transfer function (HRc) based on centre of the region with a head related transfer function (HRn) based on the rotated center of the new head orientation in the region. For instance, a processor such as the VR capable device replaces a pre-encoding by removing HRTF corresponding to the current head orientation (Hc) in the region (R1) (e.g., HRc) and applying HRTF corresponding to the new head orientation (Rn) in the region R1 (e.g., HRn). Accordingly, the encoded original audio content based on the HRc is modified by removing the HRc from the audio sources and applying the HRn to rotate the original audio content based on centre corresponding to the current head orientation (Hc) from the region R1 to the rotated centre corresponding to the new head orientation (Hn) of the user in the region R1. In an embodiment, the HRn (HRTF corresponding to the head orientation of the user in center of the new region(Rn)) is applied to combination of audio sources of the original audio content. The position of the HRn does not correspond to positions of any of the audio sources. In this embodiment, any HRTF that is added and removed are added or removed from all audio sources regardless of the position of the audio sources. The final left ear signals and final right ear signals are generated based on new HRTF (e.g., HRn) applied to the combined audio sources.

At 714, the method 700 includes performing playback of spatial audio based on the head related transfer function (HRn) corresponding to the new head orientation (Hn) of the user in the region. The spatial audio is now rendered to the user based on the HRTF (HRn) applied to the original audio content corresponding to the new head orientation (Hn) of the user in the region (R1). The processor performing play back switches between audio segments of the plurality of representations (based on the audio adaptation set of region R1) to playback spatial audio for the user in the region (R1) based on the new head orientation Hn.

Referring now to FIG. 7B, a flow diagram depicting an example method 750 for rotating spatial audio within a region based on change in the head orientation of a user during playback is illustrated in accordance with another example embodiment. The method 750 can be performed by the system 1000 (described with reference to FIG. 10) and has been explained with reference to binaural audio. However, it must be noted that the system 1000 can be applied to any of the spatial audio formats. The sequence of operations of the method 750 need not to be necessarily executed in the same order as they are presented. Further, one or more operations may be grouped together and performed in form of a single step, or one operation may have several sub-steps that may be performed in parallel or in sequential manner.

At 752, the method 750 includes determining the head orientation of the user in a region. During playback, the head orientation of the user may change within a region when the user switches views slightly. The head orientation of the user is determined and classified as belonging to a region of a plurality of regions. Determination of the head orientation of the user is explained with reference to FIGS. 3A-3I.

At 754, the method 750 includes rendering audio by re-panning the components using one or more amplitude panning techniques. For example, if the original signal consists of a left channel L and a right channel R, then we might pan these as if the user's ears were back-to-back cardioid microphones receiving signals from two speakers on opposite sides of the user. In this case, the panned signal for the left ear would be (1+cos(theta))*L+(1+cos(−theta))*R, where theta is the angle between the lines from the right ear to the left ear for the original and changed user head position. Such amplitude panning techniques provide low quality spatial audio. However, amplitude panning techniques are computationally cheap and require no extra channels.

At 756, the method 750 includes checking if there is a change in the head orientation of the user within the region. For instance, the user may move his/her head slightly while viewing virtual reality content, the head orientation of the user changes to a new position (the new head orientation) within the same region. If there is no change in the head orientation of the user, operation at 754 is repeated else operation at 752 is performed.

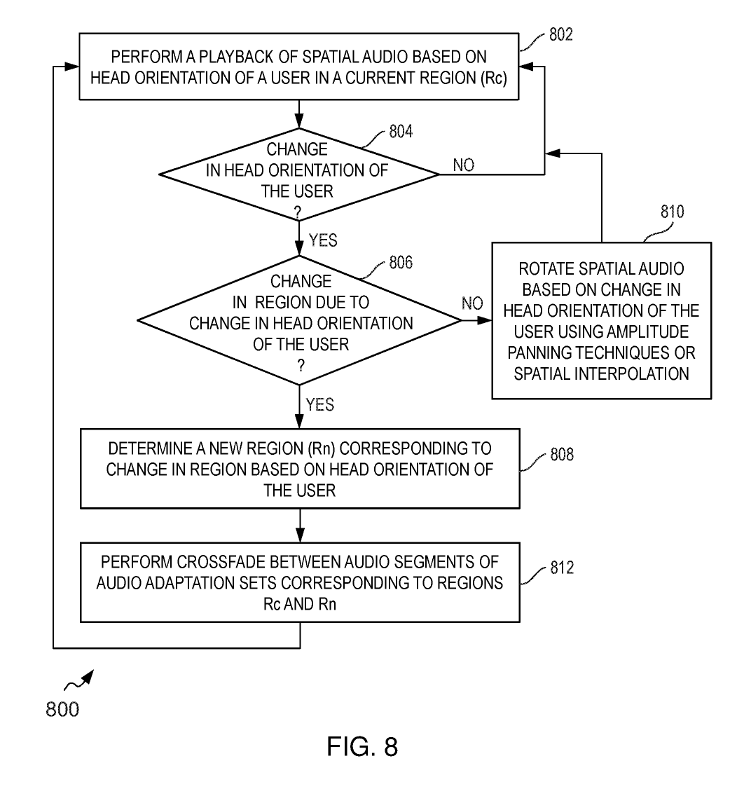

FIG. 8 illustrates a flow diagram depicting an example method 800 for smoothening and rotating spatial audio when user switches views based on change in the head orientation of a user during playback of spatial audio in accordance with an example embodiment. The method 800 can be performed by the system 1000. The sequence of operations of the method 800 need not to be necessarily executed in the same order as they are presented. Further, one or more operations may be grouped together and performed in form of a single step, or one operation may have several sub-steps that may be performed in parallel or in sequential manner.

At 802, the method 800 includes performing a playback of spatial audio based on the head orientation of a user in a current region (Rc) i.e. a source region. When the head orientation of the user is determined in the region (Rc), the system 1000 (explained with reference to FIG. 10) plays back spatial audio from an audio adaptation set corresponding to the current region (Rc). The audio adaptation set has a plurality of representations (original audio content encoded at different bit rates) that are segmented consistently, such that, the system 1000 can switch between the audio segments of the audio adaptation set corresponding to the region (Rc). Such switching between audio segments of the audio adaptation set ensures efficient bandwidth usage.

At 804, the method 800 includes checking if there is change in the head orientation of the user. For instance, the user may either switch views to a different region or slightly move his/her head within a region and the spatial audio has to be re-rendered to the user based on change in the head orientation by either smoothening spatial audio while switching between the different audio adaptation sets corresponding to different regions or rotate spatial audio within the region based on change in the head orientation within the region. If there is change in the head orientation of the user, operation 806 is performed else operation 802 is continued.

At operation 806, the method 800 includes checking if there is a change in region due to change in the head orientation of the user. If there is no change in region corresponding to the head orientation of the user, operation at 810 is performed else operation at 808 is performed.

At operation 808, the method 800 includes determining a new region (Rn) i.e. destination region, corresponding to change in region based on the head orientation (view) of the user. Determining the region based on the head orientation of the user is explained with reference to FIGS. 3A-3I.

At operation 810, the method 800 includes rotating spatial audio based on change in the head orientation of the user using at least one of amplitude panning techniques or spatial interpolation algorithms. For instance, standard HRTF techniques are used to perform spatial interpolation of the spatial audio when change in the head orientation of the user is detected within a region. When the head orientation of the user changes slightly within the region, there is no view switch. However, the spatial audio has to be rotated based on change in the head orientation of the user within the region. In a non-limiting example, the user may slowly move his/her head within a region while viewing virtual reality content before moving to a new region. In such cases, the spatial audio has to be rotated within the region along with change in the head orientation of the user before the user switches views to another region. If the spatial audio is not rotated, the spatial audio rendered directly while the user switches views (to the new region) will exhibit pops and clicks during playback due to discontinuity in the spatial audio or abrupt change in spatial audio rendered to the user. Rotating spatial audio using spatial interpolation and amplitude panning techniques have been explained with reference to FIGS. 6A-6B and 7A-7B.

At operation 812, the method 800 includes performing crossfading using the audio adaptation sets corresponding to change in region based on change in the head orientation of the user. The audio adaptation sets corresponding to two regions based on change in regions corresponding to the head orientation of the user are used to perform crossfading. For instance, the system 1000 on detecting a change of the head orientation from the current region (Rc) to the new region (Rn), switches from playing back audio segment of the audio adaptation set corresponding to the current region (Rc) to an audio segment of the audio adaptation set corresponding to the new region (Rn). The crossfading using adaptation sets of the two regions are performed so as to minimize or totally mitigate effects of pops and clicks when the spatial audio is switched from the current region (Rc) to the new region (Rn) when the user switches views. Techniques for crossfading when the user switches views are explained in detail with reference to FIG. 5.

The method 800 continues to perform playback of the spatial audio based on the head orientation of the user in the current region at 802 after performing operation at block 810/812.

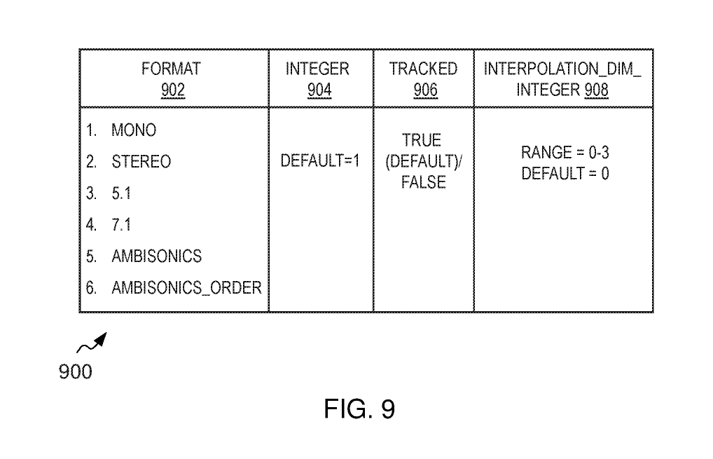

Referring now to FIG. 9, a schematic representation of a spatial audio metadata 900 for the audio adaptation sets in spatial audio is illustrated in accordance with an example embodiment. The spatial audio metadata 900 comprises one or more fields indicating a property and a corresponding value stored in the form “property=value”. It should be noted that some properties will exhibit values only if other properties take specific values and if a value is not specified explicitly for a property, then a default value is assumed for that property.

The spatial audio metadata 900 includes a format field 902, an integer field 904, a track field 906 and interpolation dimension vector field 908. The format field 902 indicates spatial audio format, such as, mono, stereo, 5.1 surround, 7.1 surround, ambisonics and higher order ambisonics. The format field 902 assumes a default value of stereo. The format specification in the format field 902 of the spatial audio metadata 900 indicates number of audio channels N required for transmitting the spatial audio. For instance, the format field 902 may assume any of a mono, stereo, 5.1 surround, 7.1 surround, ambisonics or ambisonics order and the number of channels are determine based on the spatial audio format. The integer field 904 indicates the number of channels corresponding to the spatial audio format in the format field 902. The default value is assumed to be ‘1’ channel. The first N channels of audio will be rotated in response to user head motion in a manner that depends on the format.

The track field 906 can assume either ‘true’ or ‘false’ indicating if the spatial audio is either tracked or non-tracked spatial audio. If both tracked and non-tracked spatial audio are desired, two separate VR audio streams must be used for encoding the spatial audio, one each for the tracked spatial audio and the non-tracked spatial audio. If the track field 906 assumes ‘false’ value indicating untracked-audio=true, then last two channels of spatial audio will be stereo audio that is head-locked and no attempt will be made to rotate it in response to user head motions, for example, non-diegetic sounds such as music or narration.

The interpolation dimension vector field 908 assumes an integer value between 0 to 3 and indicates number of degrees of freedom for spatial interpolation of the spatial audio when the head orientation of the user changes. If interpolation_dim is non-zero, then crossfading will be applied between the (interpolation_dim+1) streams of audio based on the user's head position. For interpolation_dim==1 the interpolation will be based on yaw (horizontal head motion only). For interpolation_dim==2 the interpolation will be based on yaw and pitch (direction the user's head is pointing to). For interpolation_dim==3 the interpolation will be based on yaw, pitch and roll (the full orientation of the user's head). It must be noted that all spatial interpolations will be done in terms of the head orientations, not in terms of angles. This avoids the peculiarities of gimbal lock while interpolating based on Euler angles that affect computer animation. The interpolation will be based on the position of the user's head orientation with respect to the orientations given by the values of interpolation vectors. Additionally, if the interpolation dimension vector field 908 for spatial audio is a non-zero value, then the audio adaptation sets of spatial audio are modified with extra data in the form of interpolation vector elements. The interpolation vector element is described in terms of degrees of freedom of rotating spatial audio as below

Interpolation_vector=“n=N yaw=Y pitch=P roll=R”

Where Y is yaw, P is the pitch and R is roll corresponding to the head orientation of the user corresponding to an N^{th} audio stream. The values for N, R, P and Y must lie in the ranges

0<=N<=3

−180<=R<180

90<=P<=90

−180<=Y<180

It must be noted that all the audio adaptation sets that are part of the same VR audio track must use identical values for the fields 902, 904, 906 and 908 in the spatial audio metadata 900. The spatial audio metadata 900 is not defined at period level in order to allow the use of multiple audio streams with different formats and different sets of views. It shall be noted that the term ‘period’ used herein to describe spatial audio metadata 900 is consistent with MPEG-DASH technique.

FIG. 10 is a block diagram of a system 1000 configured to generate spatial audio in VR applications, in accordance with an example embodiment. The system 1000 is also configured to perform playback of the spatial audio in VR applications. The system 1000 is an example of the view adaptive spatial audio generator 112, and/or can be embodied in the VR capable device 114.

The system 1000 includes at least one processor such as a processor 1002 and at least one memory such as a memory 1004. The system 1000 also includes an input/output (I/O) module 1006 and a communication interface 1008. The system 1000 may be deployed as an electronic device, or in some embodiments the system 1000 may embody the electronic device. For example, the system 1000 may be deployed in an automatic signal processing device. In some embodiments, the system 1000 may be deployed in a virtual reality camera and configured to playback spatial audio on one or more electronic devices. In some embodiments, various applications within an electronic device may call upon services of the system 1000, either directly or from remote locations, to generate view adaptive spatial audio and perform playback of the view adaptive spatial audio corresponding to video content of the virtual reality camera.

Although the system 1000 is depicted to include only one processor 1002, the system 1000 may include more number of processors therein. In an embodiment, the memory 1004 is capable of storing platform instructions 1005, where the platform instructions 1005 are machine executable instructions associated with generating spatial audio. Further, the processor 1002 is capable of executing the stored platform instructions 1005. In an embodiment, the processor 1002 may be embodied as a multi-core processor, a single core processor, or a combination of one or more multi-core processors and one or more single core processors. For example, the processor 1002 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 1002 may be configured to execute hard-coded functionality. In an embodiment, the processor 1002 is embodied as an executor of software instructions, wherein the instructions may specifically configure the processor 1002 to perform the algorithms and/or operations described herein when the instructions are executed.

The memory 1004 may be embodied as one or more volatile memory devices, one or more non-volatile memory devices, and/or a combination of one or more volatile memory devices and non-volatile memory devices. For example, the memory 1004 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory including ROM and/or RAM (random access memory), etc.).

The input/output module 1006 (hereinafter referred to as the ‘I/O module 1006’) is configured to facilitate provisioning of output to a user of the system 1000. In an embodiment, the I/O module 1006 may be configured to provide a user interface (UI) configured to provide options or any other display to the user. The I/O module 1006 may also include mechanisms configured to receive inputs from the user of the system 1000. The I/O module 1006 is configured to be in communication with the processor 1002 and the memory 1004. Examples of the I/O module 1006 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 1002 may include I/O circuitry configured to control at least some functions of one or more elements of the I/O module 1006, such as, for example, a speaker, a microphone, a display, and/or the like. The processor 1002 and/or the I/O circuitry may be configured to control one or more functions of the one or more elements of the I/O module 1006 through computer program instructions, for example, software and/or firmware, stored on a memory, for example, the memory 1004, and/or the like, accessible to the processor 1002.

The communication interface 1008 is configured to enable the system 1000 to communicate with other entities, such as for example, with consuming applications of electronic devices, either via internal circuitry or over various types of wired or wireless networks. To that effect, the communication interface 1008 may include relevant application programming interfaces (APIs) to communicate with the consuming applications. In an example scenario, the communication interface 1008 may facilitate in encoding the original audio content corresponding to audio sources at different bit rates to generate an audio adaptation set for a region that has a plurality of representations for the consuming applications. The communication interface 1008 may also facilitate provisioning of instructions to the consuming applications for subsequent execution of actions in response to detect the head orientation of the user in at least one region of the plurality of regions.

In an embodiment, various components of the system 1000, such as the processor 1002, the memory 1004, the I/O module 1006 and the communication interface 1008 are configured to communicate with each other via or through a centralized circuit system 1010. The centralized circuit system 1010 may be various devices configured to, among other things, provide or enable communication between the components (1002-1008) of the system 1000. In certain embodiments, the centralized circuit system 1010 may be a central printed circuit board (PCB) such as a motherboard, a main board, a system board, or a logic board. The centralized circuit system 1010 may also, or alternatively, include other printed circuit assemblies (PCAs) or communication channel media.

The system 1000 as illustrated and hereinafter described is merely illustrative of a system that could benefit from embodiments disclosed herein and, therefore, should not be taken to limit the scope of the invention. It is noted that the system 1000 may include fewer or more components than those depicted in FIG. 10.

As explained above, the system 1000 may embody an electronic device. In another embodiment, the system 1000 may be a standalone component in a virtual reality camera configured to capture 3-dimensional audio and video of the region surrounding the virtual reality camera and connected to a communication network and capable of executing a set of instructions (sequential and/or otherwise) for generating spatial audio for the VR content. Moreover, the system 1000 may be implemented as a centralized system, or, alternatively, the various components of the system 1000 may be deployed in a distributed manner while being operatively coupled to each other.

In various embodiments, the processor 1002 in conjunction with the memory 1004 is configured to cause the system 1000 to perform various embodiments of encoding process and playback of the spatial audio in VR applications, as described with reference to FIGS. 1 to 9.

Various example embodiments disclosed herein are capable of generating view adaptive spatial audio that adaptively switches spatial audio based on change in the head orientation of a user. Various example embodiments suggest techniques for concatenating audio segments corresponding to different regions when user switches view from one region to another region. The generation of an audio adaptation set for each region that encompasses a plurality of representations enables switching between audio adaptation sets of different regions. Moreover, the plurality of representations are original audio content encoded at different bit rates compensate for bandwidth requirement by switching between different segments of the plurality of representations in an audio adaptation set. The segmentation process ensures optimal rendering of spatial audio when the region corresponding to the head orientation of the user changes. Further, the audio adaptation sets are used to perform crossfading between disjoint (non-overlapping) audio segments corresponding to two different regions when the user switches view (change in region corresponding to the head orientation). The audio adaptation sets can be used to smoothen spatial audio during view transitions of the user and mitigate effects of pops and clicks in the spatial audio during transition. Further, spatial interpolation techniques using adaptive HRTFs that are modified for each region as the head orientation of the user changes, allow rotation of spatial audio to adapt to view transitions of the user. Moreover, amplitude panning techniques using mid/mid-side components for rotating spatial audio during view switches of the user are computationally cheap and require no extra channels.

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 10. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims.

What is claimed is:

1. A method comprising:
facilitating, by a processor, receipt of a spatial audio, the spatial audio comprising a plurality of audio adaptation sets, each audio adaptation set associated with a region among a plurality of regions, each audio adaptation set comprising one or more audio signals encoded at one or more bit rates, each of the one or more audio signals segmented into a plurality of audio segments;
detecting, by the processor, a change in region from a source region to a destination region associated with a head orientation of a user due to change in the head orientation of the user, the source region and the destination region from among the plurality of regions; and
facilitating, by the processor, a playback of the spatial audio, the playback comprising, at least in part to, perform crossfading between at least one audio segment of the plurality of audio segments of each of the source region and the destination region.

2. The method as claimed in claim 1, wherein the plurality of audio segments are non-overlapping audio segments on a time scale.

3. The method as claimed in claim 2, wherein performing crossfading comprises:
accessing, by the processor, a source audio segment from the plurality of audio segments of the source region;
accessing, by the processor, a destination audio segment from the plurality of audio segments of the destination region; and
applying, by the processor, a crossfade function for a transition time to the source audio segment and the destination audio segment for performing crossfading.

4. The method as claimed in claim 1, wherein the plurality of audio segments are overlapping audio segments on a time scale.

5. The method as claimed in claim 4, wherein performing crossfading comprises:
accessing, by the processor, a source audio segment from the plurality of audio segments of the source region;
accessing, by the processor, a destination audio segment from the plurality of audio segments of the destination region, the destination audio segment staggered in time for facilitating overlapping with the source audio segment for a transition time; and
applying, by the processor, a crossfade function for the transition time to the source audio segment and the destination audio segment for performing crossfading.

6. The method as claimed in claim 4, wherein performing crossfading comprises:
accessing, by the processor, a source audio segment from the plurality of audio segments of the source region;
accessing, by the processor, a destination audio segment from the plurality of audio segments of the destination region, the source audio segment and the destination audio segment overlap for a transition time; and
applying, by the processor, a crossfade function for the transition time to the source audio segment and the destination audio segment for performing crossfading.

7. The method as claimed in claim 6, wherein facilitating playback comprises:
performing, by the processor, playback of subsequent audio segments of an audio adaptation set of the destination region after a delay from a start time of the subsequent audio segments, the delay corresponds to the overlap between the subsequent audio segments of the audio adaptation set.

8. The method as claimed in claim 1, wherein performing crossfading comprises:
accessing, by the processor, at least one audio stream corresponding to each vertex of a plurality of vertices associated with the head orientation of the user in at least one region of the plurality of regions; and
rendering, by the processor, the spatial audio to the user based on the head orientation of the user in the at least one region, wherein the rendering comprises applying a mixing weight to the at least one audio stream from each vertex based at least on barycentric coordinates.

9. The method as claimed in claim 1, further comprising:
defining, by the processor, the plurality of regions around head of the user, each region associated with at least one view of the user based on the head orientation of the user.

10. The method as claimed in claim 1, wherein the plurality of regions are unequal regions.

11. The method as claimed in claim 1, wherein the spatial audio is at least a binaural audio signal comprising a left audio signal and a right audio signal.

12. A system, comprising:
a memory to store instructions; and
a processor coupled to the memory and configured to execute the stored instructions to cause the system to at least:
facilitate receipt of a spatial audio, the spatial audio comprising a plurality of audio adaptation sets, each audio adaptation set associated with a region among a plurality of regions, each audio adaptation set comprising a plurality of audio signals encoded at a plurality of bit rates, each of the plurality of audio signals segmented into a plurality of audio segments;
detect a change in region from a source region to a destination region associated with a head orientation of a user due to change in the head orientation of the user, the source region and the destination region from among the plurality of regions; and
facilitate a playback of the spatial audio, the playback comprising, at least in part to, perform crossfading between at least one audio segment of the plurality of audio segments of each of the source region and the destination region.

13. The system as claimed in claim 12, wherein the plurality of audio segments are non-overlapping audio segments on a time scale.

14. The system as claimed in claim 13, wherein for performing crossfading the system is caused to:
access a source audio segment from the plurality of audio segments of the source region;
access a destination audio segment from the plurality of audio segments of the destination region; and
apply a crossfade function for a transition time to the source audio segment and the destination audio segment for performing crossfading.

15. The method as claimed in claim 12, wherein the plurality of audio segments are overlapping audio segments on a time scale.

16. The method as claimed in claim 15, wherein for performing crossfading the system is caused to:
access a source audio segment from the plurality of audio segments of the source region;
access a destination audio segment from the plurality of audio segments of the destination region, the destination audio segment staggered in time for facilitating overlapping with the source audio segment for a transition time; and
apply a crossfade function for the transition time to the source audio segment and the destination audio segment for performing crossfading.

17. The system as claimed in claim 15, wherein for performing crossfading the system is caused to:
access a source audio segment from the plurality of audio segments of the source region;
access a destination audio segment from the plurality of audio segments of the destination region, the source audio segment and the destination audio segment overlap for a transition time; and
apply a crossfade function for the transition time to the source audio segment and the destination audio segment for performing crossfading.

18. The system as claimed in claim 12, wherein the system is further caused to:
define the plurality of regions around head of the user, each region associated with at least one view of the user based on the head orientation of the user.

19. A VR capable device, comprising;
one or more sensors configured to determine a head orientation of a user;
a memory for storing instructions; and
a processor coupled to the one or more sensors and configured to execute the stored instructions to cause the VR capable device to at least perform:
facilitating receipt of a spatial audio, the spatial audio comprising a plurality of audio adaptation sets, each audio adaptation set associated with a region among a plurality of regions, each audio adaptation set comprising a plurality of audio signals encoded at a plurality of bit rates, each of the plurality of audio signals segmented into a plurality of audio segments;
detecting a change in region from a source region to a destination region associated with the head orientation of the user due to change in the head orientation of the user, the source region and the destination region from among the plurality of regions; and
facilitating a playback of the spatial audio, the playback comprising, at least in part to, perform crossfading between at least one audio segment of the plurality of audio segments of each of the source region and the destination region.

20. The VR capable device as claimed in claim 19, wherein the VR capable device is further caused to perform:
accessing a source audio segment from the plurality of audio segments of the source region;
accessing a destination audio segment from the plurality of audio segments of the destination region; and
applying a crossfade function for a transition time to the source audio segment and the destination audio segment for performing crossfading.
